(19) United States
(12) Patent Application Publication
(10) Pub. No.: US 2026/0002735 A1
(43) Pub. Date: Jan. 1, 2026

(54) FURNACES FOR MELTING PARTICULATE MATERIALS

(71) Applicant: L'Air Liquide, Société Anonyme pour I'Etude et I'Exploitation des Procédés Georges Claude, Paris (FR)

(72) Inventors: Tao YAN, Shanghai (CN); Remi TSIAVA, Saint German-les-Corbeil (FR); Ting ZHANG, Shanghai (CN); Yuquan GU, Shanghai (CN)

(21) Appl. No.: 19/247,371

(22) Filed: Jun. 24, 2025

(30) Foreign Application Priority Data
Jun. 26, 2024 (CN) 202410843593.1

(51) Int. Cl. F27B 3/18; C03B 5/04; F27B 3/26; F27D 17/18; F27D 99/00

(52) U.S. Cl. CPC F27B 3/18; F27B 3/26; F27D 17/18; F27D 99/0033; C03B 5/04; F27D 2099/0036

(57) ABSTRACT

The present application discloses a furnace for melting particulate materials configured with a furnace chamber, a feed hopper, a protrusion and at least one burner. The particulate materials fall along the protrusion into a melting tank, and flue gas generated by the burner flows upwardly, thereby preheating the particulate materials. The process of utilizing the flue gas to preheat the particulate materials begins with the flue gas in the high temperature section. The efficiency of preheating the particulate materials with the flue gas greatly improves and the heat loss reduces.

### CROSS REFERENCE TO RELATED APPLICATIONS

This application claims the benefit of priority under 35 U.S.C. § 119 (a) and (b) to Chinese Patent Application No. CN202410843593, filed Jun. 26, 2024, the entire contents of which are incorporated herein by reference.

### TECHNICAL FIELD

The present invention relates to the field of melting and relates to melting devices for melting materials. More specifically, it relates to furnaces for melting particulate materials.

### BACKGROUND ART

Rock wool (mineral wool or stone wool) is a fibrous material formed by spinning or stretching molten minerals or rocks. Rock wool can be used for insulation, filtration and soundproofing. Traditionally, the conventional method of making a melt of rock fiber or slag fiber is to use a shaft furnace. Through the combustion of fuel in the shaft furnace, the self-supporting stack of the particulate materials is heated. The stack is progressively melted while being replenished from a top portion, such that the molten materials flow downward along the stack and are thereby discharged from a furnace bottom. A common furnace used for this purpose is the cupola furnace. The particulate materials described above are coarse crushed rock, pulverized stone or crushed slag, or briquettes formed from tiny particulate material. The dry particulate materials have a low heat transfer coefficient and radiation emission coefficient, making it a poor conductor of heat. Consequently, the accumulating particulate materials degrade the thermal energy transferred from the burner. Even if the surface of the stack is softened by melting, the interior of the stack remains unevenly heated.

The invention patent with the publication number U.S. Pat. No. 11,254,599B2 discloses exemplary apparatus for producing rock wool using a cupola furnace. Rock wool and cast iron are produced in the cupola furnace by melting, for example, basalt, blast furnace slag and coke. After separation of the slag and the cast iron containing most of the metals, a final step is performed to obtain the rock wool by bonding. This type of hot air combustion-aided melting technology uses hot air as the combustion-supporting gas, which is obtained by heat exchange between the exhaust gas of the cupola furnace and cold air. However, in this method, due to the low oxygen content in the air, the furnace heating rate is slow. Fuel combustion is not sufficient, resulting in high content of CO and other gases in the furnace. The produced rock wool fiber is short and thick, with poor flexibility and elasticity.

The Chinese invention patent with publication number CN110922028B discloses a furnace device for producing glass, basalt fiber or rock wool. A schematic diagram of the furnace device is shown in FIG. 1. The inner surface of the rear section of the bottom wall 304 of the furnace body 30 is raised upwardly as a whole to form the bottom of the pre-melting tank 34. The bottom of the pre-melting tank is protruded upwardly as a whole to form a tab 35 near the discharge side. A flue gas vent 31 is provided at the upper part of the rear side wall 302, and the flue gas vent 31 is higher than the tab 35. A pair of first combustion lances 50 is symmetrically provided above the pre-melting area near the discharge side of the pre-melting tank, and the two first combustion lances 50 are inserted into the furnace chamber from the left and right side walls of the furnace body respectively, while the nozzles of the two combustion lances are opposite to each other and both of them are directed to the pile of raw materials. Four pairs of second combustion lances 60 are inserted into the furnace chamber from the left and right side walls of the furnace body. The silos are provided at the top of the rear side of the furnace. The disadvantages of this type of furnace are high investment and very low efficiency of waste heat recovery. The contact time between the flue gas and the materials is very short. The dead zone of solidification formed by the natural accumulation of the materials is too large, which produces a large amount of waste material that cannot be melted.

One or more burner nozzles provided under the melt surface allow the burner flame and/or combustion products to pass through the melt. This setup is referred to as a submerged burner. An American Patent with the publish number of U.S. Pat. No. 10,336,640 B2 publishes a method and apparatus for melting solid raw materials using submerged burners. The melting chamber is equipped with at least five submerged burners, wherein each one has a burner central axis protruding from its outlet. The submerged burners are provided in a substantially annular combustion area. At the bottom of the melting chamber, neighboring burners are spaced apart and controlled such that simulations performed by computational fluid dynamics analysis show the generation of a substantially annular melt flow in the melt. The burners are provided at a suitable distance of about 250 to 750 mm from the side walls of said combustion chamber. This is to avoid the build-up of too large a layer of solidified material on the wall, too large a distance from the burner will produce undesirable melt flow and may be the cause of a dead zone with less melt mixed in the center of the furnace, and consequently lead to a reduced homogeneity of the melt.

The disadvantages of the above prior technologies are also very obvious. The flue gas from the furnace can reach temperatures up to 1350° C. or more, and this portion of the flue gas takes away about 17 to 21% of the energy. Conventional technology adds a waste heat boiler or heat exchanger to the low temperature section of the flue. The flue gas in the high temperature section is not fully utilized, so the heat recovery efficiency of the flue gas is low. Coupled with the softening of materials such as rock wool at high temperatures, the area in the high temperature section is prone to clogging. Sometimes electric furnaces help increase the melting area, however, electric furnaces are easy to damage with a short service life and high maintenance costs.

### SUMMARY OF THE INVENTION

It is a general object of the present disclosure to provide a furnace for melting particulate materials, wherein the furnace has a significantly higher flue gas heat recovery rate.

A first aspect of the present application provides a furnace for melting particulate materials, wherein the furnace is configured with:
a furnace chamber, the furnace chamber being provided with a side wall, a bottom wall, and a melting tank having a melt surface;
a feed hopper configured to supply particulate materials into the furnace chamber, said feed hopper being provided with a feed opening;
a protrusion, the protrusion being positioned between the feed opening and the melting tank, and the projection being projected upwardly from the bottom wall of the furnace chamber, whereby the particulate materials descend along a stacking surface into the melting tank; and
at least one burner, configured to heat the particulate materials in the melting tank to form a melt and generate flue gas.

According to an exemplary embodiment of the present invention, wherein the flue gas flows upwards along the stacking surface, thereby preheating the particulate materials.

According to an exemplary embodiment of the present invention, a dead zone and a flow layer are formed sequentially from the stacking surface to a side wall of the furnace chamber.

According to an exemplary embodiment of the present invention, wherein the protrusion is shaped as a multi-gradation stepped configuration, a step-like, a rectangular block, a trapezoidal block or a conical block.

According to an exemplary embodiment of the present invention, the top of the protrusion is located below the feed opening and above the melt surface.

According to an exemplary embodiment of the present invention, the protrusion is adjacent to a side wall of the furnace chamber.

According to an exemplary embodiment of the present invention, the protrusion and a melt outlet of the furnace are located on opposite sides of the furnace respectively.

According to an exemplary embodiment of the present invention, the at least one burner is adjacent to the bottom wall of said furnace chamber.

According to an exemplary embodiment of the present invention, the at least one burner is a submerged burner.

Said at least one submerged burner comprises more than two submerged burners, wherein the more than two submerged burners share a common cooling system and/or fuel and oxidant supply system.

According to an exemplary embodiment of the present invention, said submerged burner comprises a fuel passage and an oxidant passage, wherein said fuel passage and oxidant passage are constructed to respectively discharge the fuel and oxidant to the outside of the submerged burner to allow the mix of the fuel and oxidant at the outside.

According to an exemplary embodiment of the present invention, the melting tank is a rectangular shaped space enclosed by a bottom wall and four side walls.

According to an exemplary embodiment of the present invention, the height of the protrusion in the vertical direction is from 1.3 to 6 times the set value of the melt depth in the melting tank, preferably from 1.5 to 5 times, and more preferably from 2.5 to 4.5 times.

According to an exemplary embodiment of the present invention, the outermost point of the protrusion projected onto the horizontal plane downstream along the melt flow direction is marked as X, wherein a horizontal distance L1 between X and the center axis of the nearest burner is greater than 200 mm, and preferably ranging from 200 mm to 500 mm.

According to an exemplary embodiment of the present invention, downstream along the melt flow direction, the line connecting M and X, wherein M is the endpoint of the apical surface of the protrusion, forms an angle (F) with the horizontal plane in the range of degrees from 25° to 80°, preferably from 35° to 75°, and more preferably from 50° to 70°.

According to an exemplary embodiment of the present invention, downstream along the melt flow direction, the line connecting the endpoint M of the apical surface of the protrusion and X forms an angle (F) with the horizontal plane with a degree greater than the static angle of repose of the particulate materials.

According to an exemplary embodiment of the present invention, downstream along the melt flow direction, the outermost point of the feed opening projected onto the horizontal plane is marked as Y, then the horizontal distance L2 between X and Y ranges from 200 mm to 1000 mm.

According to an exemplary embodiment of the present invention, the particulate materials have a particle size ranging from 20 to 80 mm, preferably from 50 to 80 mm.

According to an exemplary embodiment of the present invention, the melting tank is an annular space enclosed by the bottom wall of the furnace and the surrounding side walls of the furnace, wherein a protrusion is positioned within the annular furnace.

According to an exemplary embodiment of the present invention, the protrusion is arranged circumferentially, and together with the bottom wall of the furnace and the side walls of the furnace, define a melting tank.

According to an exemplary embodiment of the present invention, the feed openings are arranged circumferentially at equal intervals.

A second aspect of the present application provides a method of melting particulate materials, said method comprising melting the particulate materials in a melting tank of a furnace according to the foregoing.

A third aspect of the present application provides a method of preheating particulate materials using flue gas generated from a furnace, comprising the steps:
providing a furnace, wherein the furnace comprises a furnace chamber in which particulate materials are supplied into the furnace chamber (12) via a feed hopper;
one or more burners disposed on the furnace being configured to combust the fuel and oxidant, thereby generating flue gas;
providing a protrusion, wherein said protrusion being positioned between the feed opening and the melting tank, the protrusion defining a stacking surface along which the particulate materials enter the melting tank in a direction opposite to the flue gas flow, whereby the particulate materials are preheated and at least partially melted, falling onto the melt surface.

In comparison with the prior arts, the technical solution provided in this application has the following advantages:
1. The protrusion of the furnace overall lift the pile formed by the continuously falling particulate materials, thus prolonging the contact time of the particulate materials with the flue gas.
2. The protrusion and melt outlet are arranged on opposite sides of the furnace, so the efficiency of flue gas preheating particulate materials and the heat recovery efficiency of the flue gas are significantly increased.
3. The process of preheating the particulate materials using flue gas starts from the high-temperature flue gas, and there is no need to cool down the flue gas, thereby reducing heat loss.
4. The particulate materials soften and melt during the preheating stage and enter into the melting tank, thereby accelerating the formation of the melt.
5. The flame and combustion products of the submerged burner are in direct contact with the heated medium, with long heat transfer time and full heat exchange, thereby improving energy efficiency and reducing CO₂ and NOₓ emissions.
6. The combination of submerged burners allows flexibility in meeting the requirements of various power ranges, reduces costs, and saves space by creating a more compact structure.

### BRIEF DESCRIPTION OF THE DRAWINGS

The advantages and spirits of this application are further understood by the following detailed description of the invention and the drawings.

For a further understanding of the nature and objects for the present invention, reference should be made to the following detailed description, taken in conjunction with the accompanying drawings, in which like elements are given the same or analogous reference numbers and wherein:

FIG. 1 is a schematic drawing of a furnace disclosed in a patent with the publication No. CN110922028B;

FIG. 2 is a schematic drawing of the furnace structure of Embodiment 1 provided in the present application;

FIG. 3 is a sectional drawing along line A-A in FIG. 2;

FIG. 4 is a schematic drawing of the furnace structure of Embodiment 1 provided in the present application, equipped with an exhaust gas passage;

FIG. 5 is a schematic drawing of the furnace structure of Embodiment 2 provided in the present application;

FIG. 6 is a sectional drawing along line B-B in FIG. 5;

FIG. 7 is a schematic drawing of a furnace structure of Embodiment 3 provided in the present application.

In the figures: 11 represents a furnace, 121 represents a bottom wall (of the furnace), 122 represents a side wall (of the furnace), 12 represents a furnace chamber, 13 represents a melting tank, 14 represents a feed hopper, 15 represents a feed opening, 151 represents a screw feeder, 16 represents a (submerged) burner, 17 represents a melt surface, 18 represents a protrusion, 19 represents flue gas, 20 represents a stacking surface, 21 represents a dead zone, 22 represents a flow layer, 23 represents an exhaust gas passage, 24 represents a silo, 25 represents a temperature regulating device, and 26 represents a melt outlet.

### PREFERRED EMBODIMENTS OF THE INVENTION

Specific embodiments of the present application are described in detail below in conjunction with the drawings. However, it should be understood that the present application is not limited to such embodiments described below, and that the technical ideas of the present application may be implemented in combination with other well-known technologies or other technologies that function in the same way as those well-known technologies.

In the following description of specific embodiments, in order to clearly show the structure and the way of working, it will be described with the help of a number of directional terms, but terms such as “front”, “rear”, “left”, “right”, “outer”, “inner”, “outward”, “inward”, “axial”, “radial”, etc. should be understood to be terms of convenience rather than restrictive terms.

In the following description of specific embodiments, it is to be understood that the terms “length”, “width”, “up”, “down”, “front”, “back”, “left”, “right”, “vertical”, “horizontal”, “top”, “bottom”, “inner”, “outside”, etc., indicate orientations or positional relationships based on those shown in the drawings, and are intended only to facilitate a simplified description, and are not intended to indicate or imply that the device or element referred to must have a specific orientation, be constructed and operated in a particular orientation, and are therefore not to be construed as a limitation on the present application. Furthermore, when the first structure is described as being positioned “above” or “below” the second structure, this should be understood to mean that the first structure is positioned further or closer to a horizontal plane. Herein, the plane in which the bottom wall of the furnace is located is taken to be the horizontal plane.

In addition, the terms “first” and “second” are only used for descriptive purposes rather than limiting chronological order, quantity, or importance, and should not be construed as indicating or implying relative importance or implicitly specifying the number of the indicated technical features, but merely as a means of instead, it is merely for the purpose of distinguishing one technical feature from another technical feature in the present technical solution. As a result, the feature defined with “first” or “second” may expressly or implicitly include one or more such features. In the description of this application, “multiple” (“plurality”) means two or more, unless otherwise expressly specified. Similarly, qualifiers such as “a” (“one”) appearing herein are not meant to be quantitative, but rather to describe technical features not appearing in the preceding text. Similarly, unless modified by a specific quantity measure word, nouns herein should be regarded as including both singular and plural forms, i.e. the technical solution may include a single one of the technical feature concerned, but may also include a plurality of the technical feature. Similarly, modifiers such as “approximately” and “about” appearing before numerals herein usually include the numeral (present number), and their specific meanings thereof should be understood in context.

It should be understood that in the present application, “at least one (item)” means one or more, and “multiple” means two or more. The expression “and/or” is used to describe the associative relationship between associated objects, and indicates that three relationships may exist. For example, “A and/or B” may mean three situations: A alone is present, B alone is present, and A and B are both present, wherein A and B may be singular or plural. The symbol “/” generally indicates an “or” relationship between the associated objects before and after it. “At least one of the following items (pieces)” or a similar expression means any combination of these items, including a single item (piece) or any combination of multiple items (pieces). For example, at least one (item) of a, b or c can mean: a, b, c, “a and b”, “a and c”, “b and c”, or “a and b and c”, wherein a, b and c may be single or multiple.

For the purposes of this application, unless otherwise expressly provided and limited, the terms “mounting”, “connecting”, “joining”, “fixing” and the like shall be broadly construed, for example, there may be a fixed connection, a removable connection, or a one-piece connection; there may be a mechanical connection or an electrical connection; there may be a direct connection or an indirect connection through an intermediary medium; there may be a connectivity within the two elements or an interactive relationship between the two elements. For those persons skilled in the art, the specific meanings of the above terms in this application may be understood on a case-by-case basis. “Fixedly coupled” or “fixedly connected” or “inactively coupled” is understood to mean that the connection between two or more structural members is not constructed to provide relative motion. An embodiment of a fixed connection is welded connection or bolted connection, and in some cases welds connection and screw connection. “Movably connected” or “movable” or “mobile connection” is understood to refer to a connection between two or more structural members that allows horizontal and/or vertical relative movement between the members under extreme dynamic loads. Such a connection does not normally allow movement under static or general dynamic loads (e.g., as imposed by light/moderate winds).

The terms “unit,” “piece,” “thing,” and “module” described in this specification mean a unit for processing at least one function and operation and may be implemented by hardware components or software components and a combination thereof.

The terms “upstream” and “downstream” as described in this specification are defined with respect to the expected flow of fluid (e.g., melt in the furnace). The upstream end corresponds to the end closest to the inlet that introduces fluid into the furnace. The downstream end corresponds to the outlet or nozzle end at which the fluid leaves the furnace. Further, the location or area further away from the protrusion is downstream of the melt flow direction, while the location or area further close to the protrusion is upstream of the melt flow direction.

Unless clearly indicated to the contrary, each aspect or embodiment limited herein may be combined with any other one or more aspects or one or more embodiments. In particular, any feature noted as preferred or advantageous may be combined with any other feature noted as preferred or advantageous.

### Terms

A furnace is a kiln suitable and/or configured to melt particulate materials. The particulate materials may refer to any materials suitable for the manufacture of fibers, including but not limited to, glass fibers, mineral fibers, rock fibers, or slag fibers. The raw material for producing rock wools or basalt fibers is block rock. The melting of the block rock in the furnace is a process of absorbing heat from a cold solid state to softening and melting. The melting temperature of block rock is usually above 1000° C., so the energy consumption of the furnace is particularly high. Rock wool is a mineral made from natural ores such as basalt (or gabbro), and is made into products such as rock wool panels, rock wool felts, and rock wool pipe casings according to different applications. The particle size of the particulate materials used in the present application ranges from 0.05 mm to 80 mm, preferably the particle size ranges from 20 mm to 80 mm.

For stacked particulate material systems, the Angle of Repose is one of the most important parameters describing the fundamental properties of the particles in relation to their friction. Angle of Repose refers to a finite angle at which a particle stack can remain stationary relative to the horizontal plane. In practice, the angle of repose can take on a range of values before the stacking pile loses stability, i.e., there is a maximum stability angle before collapse occurs. A large amount of particulate materials dump on the horizontal surface and pile up into a cone. The internal angle of between the surface of the pile and the horizontal plane is the angle of repose. The angle of repose is related to particle density, particle surface area, particle shape and friction coefficient.

The angle between the inclined plane presented by the free pile and the stationary horizontal plane is the static angle of repose. When measuring the static angle of repose, due to the presence of fine particles in the loose particulate materials, when it piles up to a certain extent, under the action of gravity or impact force, a part of the loose pile is prone to collapse. The air encapsulated between the particles of the loose pile changes its fluidity, thereby the actual angle of repose is often lower than the theoretical value of the static angle of repose. When there are more large-size loose piles, less small-size materials and more air in the loose piles, the angle between the hypotenuse and the bottom edge of the loose pile collapse is often not equal to the theoretical value of the static angle of repose either.

Those persons skilled in the art are familiar with a variety of methods for measuring the static angle of repose, such as powder physical property testers. The discharge angle method, the injection angle method, the sliding angle and the shear box method are common methods of testing the angle of repose of powder.

As used herein, the term “fuel” refers to gaseous, liquid or solid fuels that can be used interchangeably or in combination. If it is at least partially in gaseous form, it can be introduced directly into the burner. If it is in liquid or solid form, it is introduced in the vicinity of the burner. The gaseous fuel may be natural gas (primarily methane), propane, hydrogen, syngas, biomass gas or any other hydrocarbon compound and/or sulfur-containing compound and/or nitrogen-containing compound. The solid or liquid fuel may be predominantly any compound in carbon and/or hydrocarbon and/or sulfur-containing form. The persons skilled in the art may determine the method of introducing the gaseous fuel, liquid fuel or solid fuel as desired, and the present invention is not intended to impose any limitation.

As used herein, the term “nozzle” refers to the component located at the end of the burner that ejects the fuel and oxidant to cause combustion thereof, either as a stand-alone component or as an integral component with other components.

As used herein, the terms “melt”, “fuse” include the operations of heating a heated medium from a substantially solid state to a substantially liquid state. The composition of the heated medium may exist in any state between a substantially solid state and a substantially liquid state, including a substantially solid state and a substantially liquid state, wherein such state is between a solid particulate material and a melt with any extent of partial melting.

As used herein, the term “melt” or “molten material” refers to a substance obtained by melting that may comprise an inorganic constituent, a metal or an organic constituent, etc., which may be molten rockwool, molten glass, molten metals, molten resins, molten wastes, and the like.

As used herein, the term “preheating” refers to the heating of the particulate materials prior to its introduction into the melting tank.

As used herein, refractory materials defines as materials and products whose heat resistance corresponds to at least 1500° C. (without excluding materials containing metallic components). This definition implies that the refractory materials should withstand at least 1500° C. without softening or collapsing under their own weight according to the heat resistance test criteria. The surface in contact with the molten material or melt may be a combination of a water jacket assembly or a refractory material. The water cooling jacket assembly may be a pipeline network structure that allows the passage of a cooling fluid such as water. The protrusion may comprise a water cooling jacket assembly or refractory materials.

Specific embodiments of the present application are described in detail below in conjunction with the drawings. Embodiments may be found throughout the drawings in multiple views. Identical markings in the embodiments generally indicate the same or corresponding components. Accordingly, the descriptions of the embodiments are incorporated into one another, and descriptions of common subject matter of each embodiment are generally not repeated herein.

### Embodiment 1

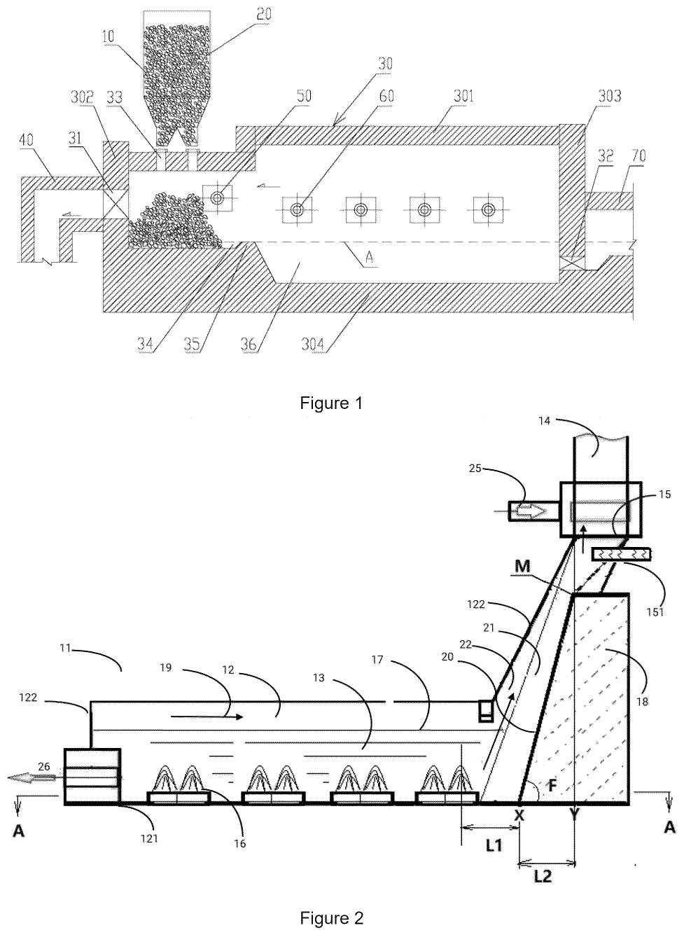

FIG. 2 illustrates the structure schematic view of an exemplary furnace of the present invention. The furnace 11 has a furnace chamber 12 for melting particulate materials. The furnace chamber 12 is configured with a melting tank 13, i.e. a space for melting, which is enclosed by at least a bottom wall 121 and a side wall 122. The body of the furnace 11 is made of refractory materials. The melting tank 13 is, for example, a substantially rectangular shaped space enclosed by a bottom wall 121 and four side walls 122.

The feed opening 15 of the one or more feed hoppers 14 is oriented toward the bottom wall 121 of the furnace. The particulate materials fall through the feed opening 15. At this point the feed opening 15 and the melt outlet 26 of the furnace are located on opposite sides of the furnace respectively. A feeding system such as a feed hopper is used, which is well known to the persons skilled in the art. In this embodiment, basalt ore and dolomite ore with a particle size ranging from 20 to 80 mm (preferably 50 to 80 mm) are selected as examples. The centers of blocks with a larger particle size are very difficult to heat. If the particulate materials also include some powdered particulate materials with a particle size in the range of 0.05 to 2 mm, a screw feeder 151 can be used in conjunction with the feeding. The screw feeder 151 may be mounted horizontally to one side of the feed opening 15, and this portion of the powdered materials is supplied into the particulate materials falling through the feed opening 15 and mixed therein, moving together downstream.

At least one submerged burner 16 arranged on the bottom wall 121 provides thermal energy. The thermal energy transfers from the submerged burner flame to the melt surface 17. The submerged burner 16 extends upwardly from the bottom wall 121 into the melt. The fuel and oxidant introduced from a nozzle at the end of the submerged burner 16 burned to produce flue gas 19. The submerged burner preferably ejects the combustion products into the melt at high pressure. The flue gas 19 rises through the melting tank 13, and the particulate materials enter the melting tank 13 in a direction opposite to the escaping flue gas 19. The particulate materials are thus preheated and at least partially melted. For a given submerged burner design, the persons skilled in the art need to adjust the distance between the burners and between the burners and the walls. At the bottom of the furnace, adjacent burners are spaced apart and controlled. A plurality of submerged burners 16 may share a cooling system and/or a fuel and oxidant supply system. The submerged burners 16 may include a fuel passage and an oxidant passage (not shown in the illustrations). Said fuel passage and oxidant passage are constructed to discharge the fuel and oxidant respectively to allow mixing of the fuel and oxidant to occur. The flame direction of the submerged burner mounted on the bottom wall 121 of the furnace is upward. Exemplarily, the angle between the extension of the flame direction and the vertical direction lies between 0 and 10°.

Advantageously, submerged burners can use hydrogen as the fuel. Hydrogen has many advantages as a clean energy source. Since the submerged combustion conducts heat transfer and heat convection by direct contact, the heat of the hydrogen flame is fully transferred in the heated materials, thus enabling better utilization of the heat energy of hydrogen combustion. Hydrogen as a fuel for submerged burners also has the following advantages: water is the only product of its oxidation combustion, thus reducing carbon dioxide emissions from the combustion process; when hydrogen is used as a fuel, the partial pressure of the gaseous water generated is different from that of the other gases present in the glass, which makes it easier for the bubbles of these gases to be absorbed and merged to form a large bubble to be discharged; in addition, lots of OH ions produced by hydrogen combustion reduce the surface tension of the glass liquid abound bubbles of various sizes, and can also make it easier for the gas in the bubbles to escape from the melt. The above advantages of hydrogen make it suitable for use as a fuel in submerged burners in material s melting.

Combined with the conditions of particle size, composition, moisture, etc. of the basalt particles in this embodiment, the theoretical value of the static angle of repose is 35°. In order to improve the heat exchange efficiency between the pile formed by the particles and the flue gas, a protrusion 18 is particularly provided. The protrusion 18 is proximate to one of the side walls of the furnace chamber, which is positioned between the feed opening 15 and the melting tank 13. Preferably, the protrusion 18 and the melt outlet 26 of the furnace are located on opposite sides of the furnace. The protrusion 18 is capable of lifting the pile formed by the continuously falling particulate materials, resulting in an increased heat exchange area between the particulate materials and the flue gas 19, and an increased effective heat transfer from the flue gas to the particulate materials. The presence of conventional dead zones can make heat exchange between the flue gas and the particulate materials particularly difficult. It is therefore a further aim of the present application to utilize the temperature of the flue gas to preheat more particulate materials, which undergo melt softening and eventually fall into the melting tank, thereby accelerating the formation of the melt in the melting tank. The protrusion 18 can withstand the pressure of the continuously descending particulate materials above it, thereby prolonging the contact time of the particulate materials with the flue gas 19. The protrusion 18 defines a stacking surface 20 in contact with the particulate materials. A dead zone 21 and a flow layer 22 are sequentially formed in an area from the stacking surface 20 to a side wall of the furnace chamber. The dead zone 21 is a retention layer of the particulate materials, wherein the particulate materials are mostly in an unmelted solid state. The flow layer 22 is the mobile layer of the particulate materials, wherein the particulate materials are in a transitional state comprising both solid and liquid states after a certain extent of softening. Other objectives are to minimize the risk of clogging of the feed stream or blockage of the flue gas due to overheated melting or high speed softening of the particulate materials.

This embodiment does not intend to limit the specific shape of the protrusion 18, which may be, for example, a multi-gradation stepped configuration or step-like, a rectangular block, a trapezoidal block, a conical block, or other pile-like structure. The top of the protrusion 18 is located below the feed opening 15 and above the melt surface 17.

The height of the protrusion 18 in the vertical direction is from 1.3 to 6 times the set value of the melt depth in the melting tank, preferably from 1.5 to 5 times, and more preferably from 2.5 to 4.5 times. The set value of the melt depth is considered a target melt height after stable operation of the furnace, i.e. the height from the melt surface 17 to the bottom wall 121 of the furnace.

The melt can be removed continuously or in batches. The melt outlet 26 is provided near the bottom wall of one of the short side walls of this rectangular melting tank. In the case of loading the particulate materials closer to a side wall of the furnace, the melt outlet for the melt is preferably arranged at a position on the opposite side to the feed opening. In case of non-continuous discharge of the melt, the opening and closing of the melt outlet can be controlled, for example by means of a ceramic piston. As the particulate materials continue to melt, the melt forms a melt surface 17 within the melting tank, which may be a top surface of the melt. The flow direction of the formed melt is shown in FIG. 2 as a generally right-to-left direction. Accordingly, the location or area to the left, near the melt outlet 26 in FIG. 2 is downstream of the melt flow direction, while the location or area to the right, away from the melt outlet 26 is upstream of the melt flow direction.

As shown in FIG. 2, downstream along the melt flow direction, the leftmost endpoint of the protrusion 18 is marked as X. The horizontal distance L1 between X and the center axis of the nearest submerged burner 16 is greater than 200 mm, and preferably 200 to 500 mm. If L1 is too small, the bubbles generated by the submerged burner 16 will impact the particulate materials descending along the protrusion, scrubbing the walls of the protrusion and affecting the effective melting of the particulate materials and the furnace life. If L1 is too large, the heat exchange efficiency between the flue gas 19 and the particulate materials decreases and the dead zone area is larger.

An example is the protrusion having a trapezoidal cross-section illustrated in FIG. 2. Downstream along the melt flow direction, the line connecting the leftmost endpoint M of the apical surface of the protrusion and X forms an acute angle (F) with the horizontal plane with a degree greater than the static angle of repose of the particulate materials, e.g. in the range of 25° to 80°, preferably in the range of 35° to 75°, and more preferably in the range of 50° to 70°. Y is the endpoint projected onto the horizontal plane of the feed opening 15 along the more downstream direction (i.e. the leftmost), and the horizontal distance L2 between X and Y ranges from 200 to 1,000 mm. The distance between X and Y ensures that the descending particulate materials are more inclined to descend along the surface of the protrusion and less likely to accumulate on the already softened particulate materials.

The technical solution of this embodiment is to preheat the particulate materials by using flue gas generated by combustion in a submerged burner of a furnace. The temperature of the flue gas leaving the melt is related to the depth of the melt in the furnace, the flame characteristics of the submerged burner, the type of fuel and oxidant, and the physical properties of the melt.

As an exemplary case, the furnace in this embodiment has a vertical height of about 1300 mm from the furnace crown to the bottom wall of the furnace. The bottom wall of the furnace is equipped with eight (8) multi-nozzle (12 nozzles) submerged burners, wherein the power of each nozzle is not more than 80 KW. Take for example, a production line in which the furnace has a discharge capacity of 120 tons/day. After the furnace has stabilized, the melt depth reaches a set value of 650 mm, at which time the melt surface in the furnace stabilizes. The vertical distance from the feed opening 15 to the melt surface is about 4 meters. The maximum height of the protrusion in the vertical direction is 3.25 meters.

FIG. 3 shows a cross-sectional view along line A-A of FIG. 2. The cross-sectional width of the feed opening 15 is approximately 70% to 100% of the width L3 of the sidewall of the charging end of the furnace.

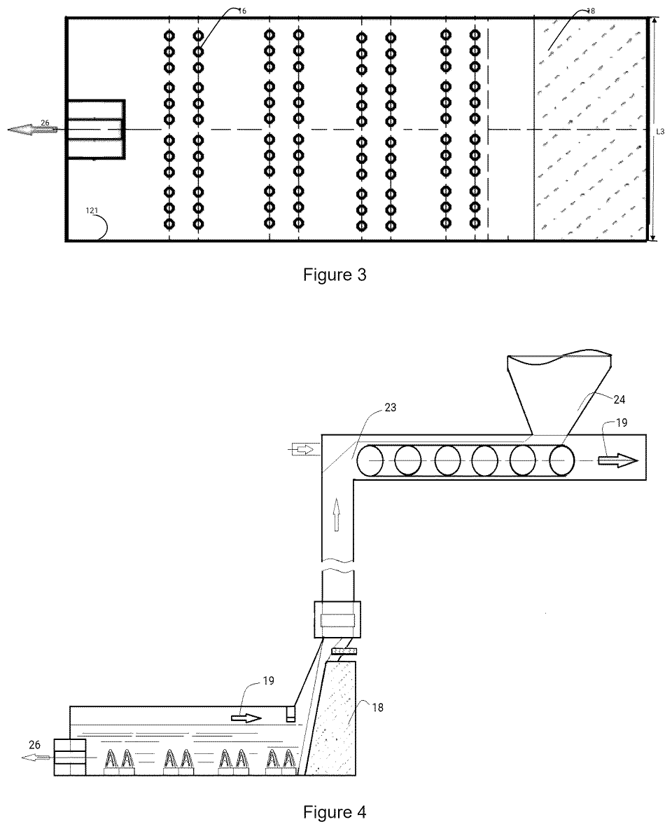

FIG. 4 further shows a schematic view of the rectangular furnace of FIG. 2 equipped with an exhaust gas channel. The flue gas exhaust leaving the furnace continues into the exhaust gas passage 23. The particulate materials conveyed by the silo 24 connected to the feed hopper initially exchanges heat with this portion of the flue gas exhaust, improving flue gas utilization.

The flue gas 19 generated from the submerged burner 16 escapes from the melt at 1500° C. and reaches a temperature of about 1350° C. to 1200° C. above the melt surface 17. In this embodiment, the flue gas can be categorized by temperature into a high temperature flue gas (temperature higher than 800° C.), a medium temperature flue gas (500˜800° C.), and a low temperature flue gas (lower than 500° C., preferably lower than 300° C., and more preferably than 150° C.). In this embodiment, the flue gas in the melting tank 13 and in contact with the descending particulate materials via the protrusion 18 is mainly the high temperature flue gas. The flue gas rising up to the vicinity of the feed opening 15 is mainly a medium temperature flue gas. The flue gas discharged through the exhaust gas passage 23 is mainly low temperature flue gas. The low temperature flue gas directly heats the particulate materials from the silo 24 and the conveyor belt or the like that transports the particulate materials. Devices for regulating the flue gas flow, such as exhaust fans, are well known to those persons skilled in the art to control the residence time of the flue gas in the furnace and will not be discussed herein. A temperature regulating device 25 is provided on one side of the feed opening 15 to control the temperature at which the flue gas exhaust enters the exhaust gas passage 23 to prevent overheating of the feed hopper 14.

Compared to the case of melting the same particulate materials in a furnace with a direct submerged burner, the heat loss can be reduced from about 21% to 5%˜13%, when the temperature of the finally escaped flue gas exhaust drops below 150° C.

### Embodiment 2

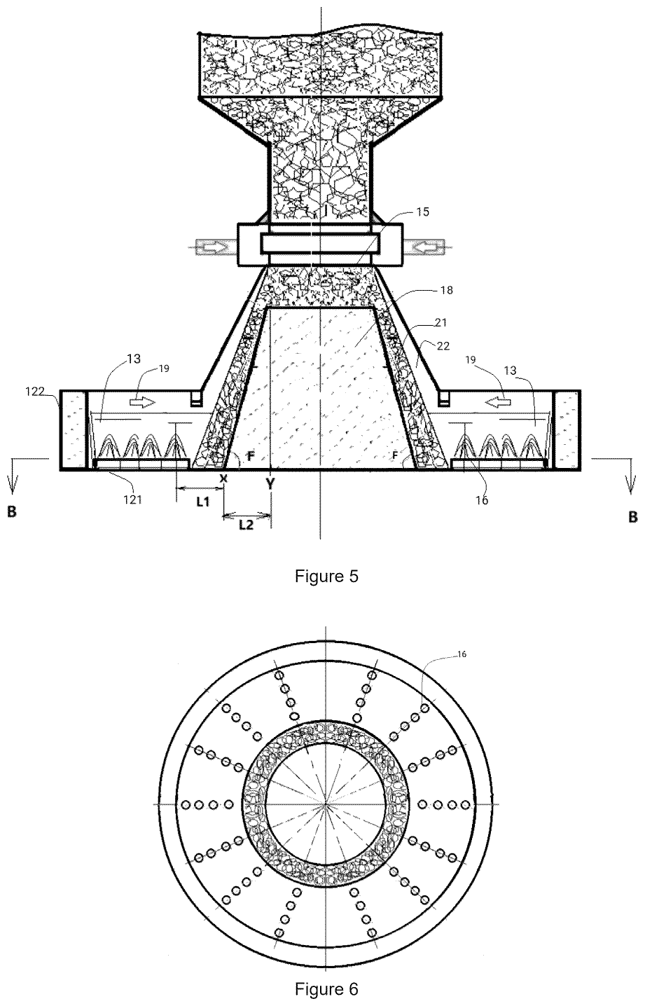

FIG. 5 illustrates a schematic view of another type of furnace of the present application. FIG. 6 then illustrates a sectional view along line B-B in FIG. 5. The furnace chamber comprises a melting tank as known to those persons skilled in the art. The melting tank 13 is an annular space surrounded by a bottom wall 121 and enclosed side wall 122, when at least one feed opening 15 is located in the center of the furnace.

The protrusion 18 is positioned within the annular furnace and preferably may be located in the center of the annular furnace. Flue gas generated by the at least one submerged burner 16 mounted on the bottom wall 121 of the furnace flows upwardly and around the circumference, in reverse contact with the falling particulate materials. The submerged burners 16 may be provided within a substantially circular combustion area. Further, each submerged burner 16 may be provided at equal intervals around the circumference of the furnace.

### Embodiment 3

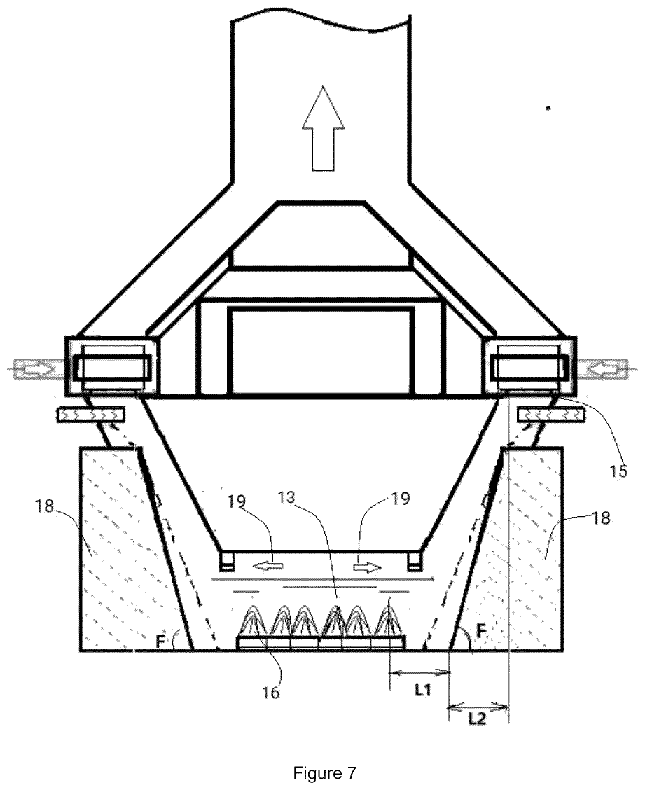

FIG. 7 illustrates a schematic view of yet another furnace of the present application. The protrusion 18 is distributed around the circumference and define a melting tank 13 with a bottom wall 121. The melting tank is positioned in the center of the furnace where a plurality of submerged burners 16 are provided. Flue gas 19 flows upwardly and around the circumference as a whole. At least one feed opening 15 may be distributed along the circumference of the annular space. Further, each feed opening 15 may be equally spaced around the circumference of the furnace. The particulate materials enter the melting tank 13 downwardly and in all directions through each feed openings 15.

The present invention makes improvements to the melting device for particulate materials of a certain range of particle sizes, in order to further eliminate the problem of particles becoming stuck and unable to continue falling due to the melting, softening and sticky of the materials. The design of the protrusion lifts the material pile, the contact area between the particulate materials and the flue gas in the high temperature section is increased, and the heat loss is greatly reduced. The nozzle of the submerged burner is submerged in the heated medium. Various power ranges can be achieved by flexible combinations of submerged burners. The furnace fully meets one or more of the previously stated objectives.

What is described in this specification is only a better specific embodiment of the present application, and the above embodiments are only used to illustrate the technical solutions of the present application rather than to limit the present application. Any technical solution that can be obtained by logical analysis, reasoning or limited experimentation by the persons skilled in the art according to the concept of this application shall be within the scope of this application.

What is claimed is:

1. A furnace for melting particulate materials, comprising:
a furnace chamber, the furnace chamber being provided with a side wall, a bottom wall, and a melting tank having a melt surface;
a feed hopper configured to supply particulate materials into the furnace chamber, said feed hopper being provided with a feed opening;
a protrusion, the protrusion being positioned between the feed opening and the melting tank, and the protrusion being projected upwardly from the bottom wall of the furnace chamber, whereby the particulate materials descend along a stacking surface into the melting tank; and
at least one burner, configured to heat the particulate materials in the melting tank to form a melt and generate flue gas.

2. The furnace for melting particulate materials as claimed in claim 1, wherein said flue gas flows upwards along the stacking surface, thereby preheating the particulate materials.

3. The furnace for melting particulate materials as claimed in claim 1, wherein a dead zone and a flow layer are formed sequentially from the stacking surface to a side wall of the furnace chamber.

4. The furnace for melting particulate materials as claimed in claim 1, wherein the protrusion is shaped as a multi-gradation stepped configuration, a step-like, a rectangular block, a trapezoidal block or a conical block.

5. The furnace for melting particulate materials as claimed in claim 1, wherein the top of the protrusion is located below the feed opening and above the melt surface.

6. The furnace for melting particulate materials as claimed in claim 1, wherein the protrusion and a melt outlet of the furnace are located on opposite sides of the furnace respectively.

7. The furnace for melting particulate materials as claimed in claim 1, wherein at least one burner is adjacent to the bottom wall of said furnace chamber.

8. The furnace for melting particulate materials as claimed in claim 1, wherein the at least one burner is a submerged burner.

9. The furnace for melting particulate materials as claimed in claim 1, wherein the melting tank is a rectangular shaped space enclosed by a bottom wall and four side walls.

10. The furnace for melting particulate materials as claimed in claim 1, wherein the height of the protrusion in the vertical direction is from 1.3 to 6 times the set value of the melt depth in the melting tank.

11. The furnace for melting particulate materials as claimed in claim 1, wherein the outermost point of the protrusion projected onto the horizontal plane downstream along the melt flow direction is marked as X, wherein a horizontal distance L1 between X and the central axis of the nearest burner is greater than 200 mm.

12. The furnace for melting particulate materials as claimed in claim 1, wherein, downstream along the melt flow direction, the line connecting the endpoint M of the apical surface of the protrusion and X forms an angle (F) with the horizontal plane with a degree greater than the static angle of repose of the particulate materials.

13. The furnace for melting particulate materials as claimed in claim 1, wherein, downstream along the melt flow direction, the line connecting the endpoint M of the apical surface of the protrusion and X forms an angle (F) with the horizontal plane in the range of degrees from 25° to 80°.

14. The furnace for melting particulate materials as claimed in claim 1, wherein, downstream along the melt flow direction, the outermost point of the feed opening projected onto the horizontal plane is marked as Y, then the horizontal distance L2 between X and Y ranges from 200 mm to 1000 mm.

15. The furnace for melting particulate materials as claimed in claim 1, wherein the melting tank is an annular space enclosed by the bottom wall of the furnace and the surrounding side walls of the furnace, wherein a protrusion is positioned within the furnace.

16. The furnace for melting particulate materials as claimed in claim 1, wherein the protrusion is arranged circumferentially, and together with the bottom wall of the furnace and the side walls of the furnace, define a melting tank.

17. The furnace for melting particulate materials as claimed in claim 16, wherein the feed openings are arranged circumferentially at equal intervals.

18. A method of melting particulate materials comprising melting the particulate materials in a melting tank of the furnace according to claim 1.

19. A method of preheating particulate materials using flue gas generated from a furnace, comprising:
providing a furnace, wherein the furnace comprises a furnace chamber in which particulate materials are supplied into the furnace chamber via a feed hopper;
one or more burners disposed on the furnace being configured to combust the fuel and oxidant, thereby generating flue gas;
providing a protrusion, wherein said protrusion being positioned between the feed opening and the melting tank, the protrusion defining a stacking surface along which the particulate materials enter the melting tank in the direction opposite to the flue gas flow, whereby the particulate materials are preheated and at least partially melted, falling onto the melt surface.
